(19) United States
(12) Patent Application Publication
(10) Pub. No.: US 2022/0053699 A1
(43) Pub. Date: Feb. 24, 2022

(54) Fruit Harvesting Apparatus and Method of Use

(71) Applicants: Dee Stevens, Hyrum, UT (US); Rex Spendlove, Millville, UT (US); Adam Brown, Logan, UT (US)

(72) Inventors: Dee Stevens, Hyrum, UT (US); Rex Spendlove, Millville, UT (US); Adam Brown, Logan, UT (US)

(21) Appl. No.: 17/520,648

(22) Filed: Nov. 6, 2021

Related U.S. Application Data
(63) Continuation-in-part of application No. 29/683,188, filed on Mar. 11, 2019.

(51) Int. Cl. A01D 46/247; B65G 11/10

(52) U.S. Cl. CPC A01D 46/247; B65G 2201/0211; B65G 11/103

(57) ABSTRACT

Disclosed is a fruit harvesting apparatus (FHA) and method of use. The FHA provides for extended reach harvesting of fruit while eliminating the need for a ladder in order to reach the fruit and for facilitating the fruit's damage-free movement from a tree to a basket or like fruit storage bin. The FHA comprises a fruit harvesting head, a handle, and a chute. In practice, a user, holding the handle, positions the harvest head around a piece of fruit such as an apple that is hanging on a tree, so that the apple is located within the head. The user then moves the head such that the stem of the apple is caught in a notch of the head, and pulls the apparatus such that the apple stem is severed and such that the apple falls into the chute and descends into a fruit receptacle without bruising or damage.

### CROSS REFERENCE TO RELATED APPLICATIONS

This nonprovisional utility patent application is a continuation-in-part of and claims the benefit under 35 USC § 120 to co-pending U.S. application Ser. No. 29/683,188 filed Mar. 11, 2019 which is expressly incorporated herein in its entirety by this reference.

### FIELD OF THE INVENTION

The present invention relates to fruit harvesting apparatuses, and in particular, to fruit harvesting apparatuses that provided for extended reach when used in easily and conveniently harvesting fruit while standing on the ground (without the use of a ladder) while preventing damage to the fruit from the fruit otherwise falling to the ground.

### BACKGROUND OF THE INVENTION

Various means and apparatuses are known in the art for extended reach fruit harvesting. However, such harvesters are not heretofore known to provide the utility of the instant invention. Examples of fruit harvesting apparatuses are disclosed in the following list of US patents and applications, all of which are expressly incorporated herein by reference: U.S. Pat. No. 5,142,854 to Chua, U.S. Pat. No. 5,253,466 to Chua, U.S. Pat. No. 5,440,867 to Strus, 20140283495 to Christensen, 20170013779 to Zhao, and 29/683,188 to Stevens.

### SUMMARY OF THE INVENTION

The present invention is a fruit harvesting apparatus (FHA) and method of use. The FHA provides for extended reach harvesting of fruit while eliminating the need for a ladder in order to reach the fruit and for facilitating the fruit's damage-free movement from a tree to a basket or like fruit storage bin. The FHA comprises a fruit harvesting head, a handle, and a chute. In practice, a user, holding the handle, positions the harvest head around a piece of fruit such as an apple that is hanging (especially high) on a tree, so that the apple is located within the head. The user then moves the head such that the stem of the apple is caught in a notch of the head, and pulls the apparatus such that the apple stem is severed and such that the apple falls into the chute and descends into a fruit receptacle without bruising or damage and without the need for the user to stand on a ladder or like elevated platform.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an assembled side schematic view of the FHA;

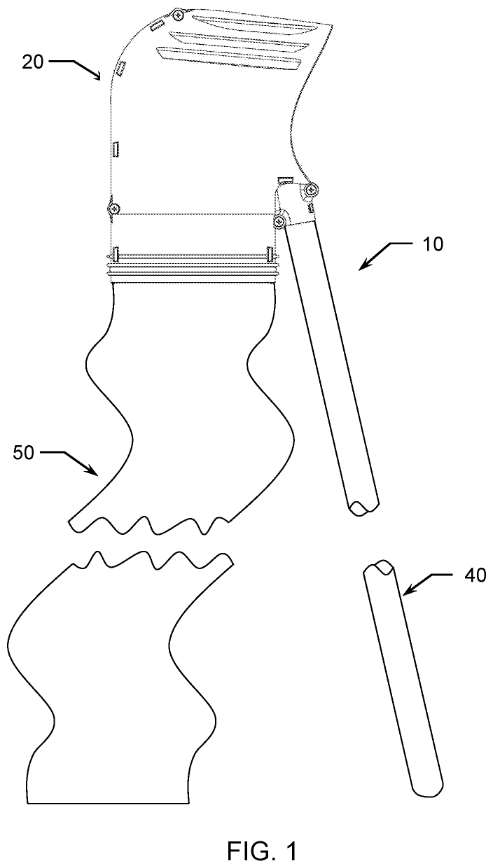

FIG. 2 is an enlarged side view of the harvest harvesting head of the FHA, and;

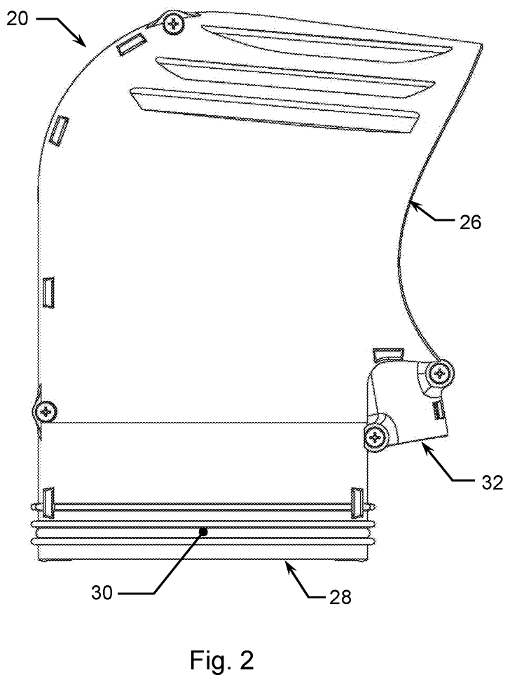

FIG. 3 is a trimetric view of the harvest harvesting head of the FHA.

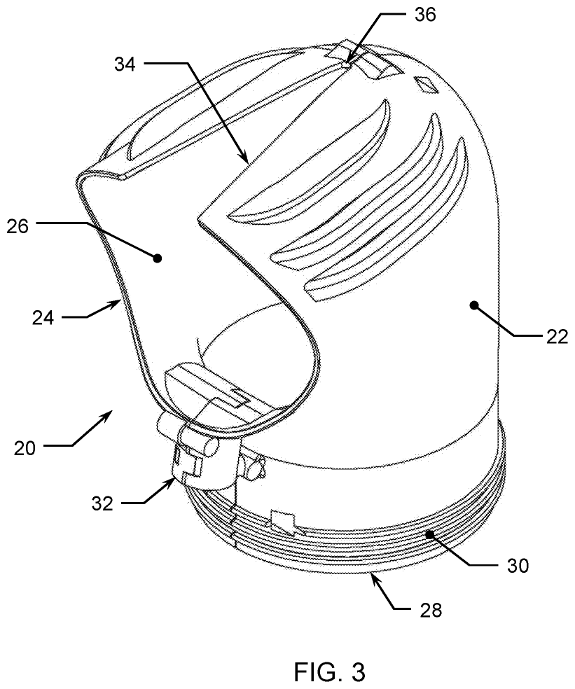

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature table is provided below. It is noted that like features are like numbered throughout all of the figures.

FEATURE TABLE

| # | Feature |
|---|---|
| 10 | Fruit harvesting apparatus |
| 20 | Harvesting head |
| 22 | First head half |
| 24 | Second head half |
| 26 | Fruit ingress opening |
| 28 | Fruit egress opening |
| 30 | Ribbed collar |
| 32 | Handle post |
| 34 | Notch |
| 36 | Notch apex |
| 40 | Handle |
| 50 | Chute |

Referring now to the drawings, a first embodiment of fruit harvesting apparatus (FHA) 10 comprises harvesting head 20, handle 40, and chute 50. Harvesting head 20 preferably defines a plastic injection molded substantially hollow elbow shaped (e.g. see for instance https://www.thefreedictionary.com/pipe+elbow) harvest head comprising (for convenience in manufacturing) first head half 22 and second head half 24 adapted so as when the two halves are assembled together (e.g. such as with mechanical fasteners), harvesting head 20 is formed. Alternatively, harvesting head 20 may comprise a single integral member. Harvesting head 20 further comprises fruit ingress opening 26, fruit egress opening 28, ribbed collar 30, preferably threaded handle post 32, notch 34, and notch apex 36. It is noted that in an alternate embodiment, harvesting head 20 may optionally include a removable blade, such as a sharpened metal blade, affixed to notch 34, so as to facilitate the severing of the stem of a piece of fruit. Handle 40 defines an elongate preferably threaded handle and may be formed for instance of wood, plastic, metal, or any suitable material. Chute 50 defines an elongate flexible/drappable (capable of being draped) preferably cloth/fabric chute such as a rip-stop nylon chute. Chute 50 may be substantially straight, or chute 50 may be formed in a serpentine pattern so as to facilitate descent of a fruit as it falls through the chute.

FHA 10 is assembled such that handle 40 is threaded into handle post 32 and an end of chute 50 is removably attached ribbed collar 30 (e.g. such as stretching chute 50 over ribbed collar 30 or by placing an elastic band over an end of chute 50 such that the elastic band nests in the ribs of ribbed collar 30 so as to retain chute 50 to ribbed collar 30).

In practice, in order to harvest a fruit, especially from a tree, without the need to stand on a ladder or like raised platform, grasping handle 40, a user, preferably while standing on the ground, positions FHA 10 such that a piece of fruit such as an apple growing on a tree, passes through fruit ingress opening 26 and is positioned within harvesting head 20, with the stem of the apple positioned within notch 34. The user then pulls or moves FHA 10 such that the stem of the apple slides to notch apex 36 and is severed. Upon severing the stem, the apple falls through fruit egress opening and through chute 50 into a fruit storage receptacle. The descent of the fall of the apple is preferably slowed/dampened by the preferably serpentine curves of chute 50 (i.e. the serpentine curves of chute 50 cause the apple to move in a side-to-side pattern as it descends thus slowing its descent). It is noted that in an alternate embodiment, a sharpened metal blade is affixed to notch 34 so as to facilitate the severing of the apple stem. It is further noted that when used to harvest fruit, the FHA preferably has no moving parts (i.e. but for flexing of the chute, preferably no one part of the FHA that moves relative to another part of the FHA).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fruit harvesting apparatus comprising a head, a handle, and a chute, wherein said head comprises a generally hollow elbow shaped head having a fruit ingress opening, a fruit egress opening, an inner cavity, a notch, and a handle post, and wherein said handle is removably attached to said handle post, and wherein said chute is removably attached to said fruit egress opening, and wherein said notch is adapted so as to sever a connection between an article of fruit and a tree on which said article of fruit is connected when said fruit is located within said inner cavity and said apparatus is pulled.

2. The apparatus of claim 1, wherein said handle is threadingly attachable/detachable to said handle post.

3. The apparatus of claim 1, wherein said chute comprises a fabric chute.

4. The apparatus of claim 1, wherein said chute includes a plurality of serpentine curves formed therein.

5. The apparatus of claim 1, wherein said chute comprises a fabric chute having a plurality of serpentine curves formed therein and adapted such that when an article of fruit descends therethrough, speed of descent of said article of fruit is slowed.

6. The apparatus of claim 1, wherein said head comprises a first head portion and a second head portion that when assembled to each other form said generally hollow elbow shaped head.

7. The apparatus of claim 1, wherein said notch includes a sharpened metal blade replaceably connected thereto.

8. The apparatus of claim 1, wherein said notch is adapted such that when a stem of an article of fruit is presented to thereto, said stem is guided to an apex of said notch.

9. The apparatus of claim 1, wherein said apparatus is substantially moving-parts-free.

10. A fruit harvesting apparatus comprising a head, a handle, and a chute, wherein said head comprises a first head portion and a second head portion that when assembled to each other form a generally hollow elbow shaped head having a fruit ingress opening, a fruit egress opening, an inner cavity, a notch, and a handle post, and wherein said notch includes a metal blade replaceably connected thereto, and wherein said handle comprises a substantially elongate handle threadingly removably attached to said handle post, and wherein said chute comprises a fabric chute removably attached to said fruit egress opening, and wherein said notch is adapted so as to sever a connection between an article of fruit and a tree on which said article of fruit is connected when said fruit is located within said inner cavity and said apparatus is pulled.

11. The apparatus of claim 10, wherein said chute includes a plurality of serpentine curves formed therein.

12. The apparatus of claim 10, wherein said chute comprises a fabric chute having a plurality of serpentine curves formed therein and adapted such that when an article of fruit descends therethrough, speed of descent of said article of fruit is slowed.

13. The apparatus of claim 10, wherein said notch is adapted such that when a stem of an article of fruit is presented to thereto, said stem is guided to an apex of said notch.

14. The apparatus of claim 10, wherein said apparatus is substantially moving-parts-free.

15. A method of harvesting fruit comprising providing a fruit harvesting apparatus comprising a head, a handle, and a chute, wherein said head comprises a generally hollow elbow shaped head having a fruit ingress opening, a fruit egress opening, an inner cavity, a notch, and a handle post, and wherein said handle is removably attached to said handle post, and wherein said chute is removably attached to said fruit egress opening, and wherein said notch is adapted so as to sever a connection between an article of fruit and a tree on which said article of fruit is connected when said fruit is located within said inner cavity and said apparatus is pulled, positioning within said inner cavity an article of fruit connected to a tree, and moving said apparatus such that said article of fruit is disconnected from said tree and moves out of said fruit egress opening and through said chute.

16. The method of claim 15, wherein said method includes the step of causing said article of fruit to descend through said chute.

17. The method of claim 15, wherein said chute comprises a fabric chute having a plurality of serpentine curves formed therein and adapted such that when an article of fruit descends therethrough, speed of descent of said article of fruit is slowed, and wherein said method includes the step of causing said article of fruit to descend through said chute.

18. The method of claim 15, wherein said handle is threadingly attachable/detachable to said handle post, and wherein said head comprises a first head portion and a second head portion that when assembled to each other form said generally hollow elbow shaped head, and wherein said notch includes a sharpened metal blade replaceably connected thereto.

19. The method of claim 15, wherein said notch is adapted such that when a stem of an article of fruit is presented to thereto, said stem is guided to an apex of said notch.

20. The method of claim 15, wherein said apparatus is substantially moving-parts-free.
